(19) United States
(12) Patent Application Publication
(10) Pub. No.: US 2025/0239196 A1
(43) Pub. Date: Jul. 24, 2025

(54) DISPLAY PANEL, DRIVING METHOD AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Bo Feng, Beijing (CN); Weifan Yang, Beijing (CN); Lei Liu, Beijing (CN); Xiaofeng Yin, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 18/702,215

(22) PCT Filed: May 6, 2023
(86) PCT No.: PCT/CN2023/092439

§ 371 Date: Apr. 17, 2024

(30) Foreign Application Priority Data
May 25, 2022 (CN) 202210580009.9

(51) Int. Cl. G09G 3/20; G09G 3/3266; G09G 3/3275; G09G 3/36

(52) U.S. Cl. CPC G09G 3/2003; G09G 3/3266; G09G 3/3275; G09G 3/3607; G09G 3/3677; G09G 3/3688; G09G 2300/0452; G09G 2320/0242

(57) ABSTRACT

A display panel includes multiple pixel circuit groups and multiple data supply line groups arranged on a base substrate; the multiple pixel circuit groups correspond to the multiple data supply line groups; the pixel circuit group includes multiple pixel units, each pixel unit includes M pixel circuits with different colors; the pixel circuit group includes 2N columns of pixel circuits, and a same column of pixel circuits included in the pixel circuit group have a same color; wherein N is a multiple of M, and both N and M are positive integers; the data supply line group includes N data supply lines; the data supply lines in the data supply line group are electrically connected to two columns of pixel circuits with the same color in a corresponding pixel circuit group, respectively, and are used to provide data signals to the two columns of pixel circuits with the same color.

### CROSS-REFERENCE TO RELATED APPLICATION

The present disclosure claims the priority of the Chinese patent application No. 202210580009.9 filed on May 25, 2022, which are incorporated herein by reference in their entireties.

### TECHNICAL FIELD

The present disclosure relates to the field of display technology, in particular to a display panel, a driving method and a display device.

### BACKGROUND

The related low-cost double gate pixel architecture has poor image quality due to insufficient charging rate during high-frequency display. For example, one column of green pixel circuits is bright and another one column thereof is dark. The macroscopic appearance is full screen of fine vertical lines. The defective analysis conclusion is vertical line due to insufficient charging of the green pixel circuit. In the related dual gate pixel architecture, one data line drives pixel circuits of different colors. This feature causes the pixel circuit to be insufficiently driven at high frequencies when displaying mixed-color images, and line defects are caused in macroscopic appearance.

### SUMMARY

In one aspect, the present disclosure provides in some embodiments a display panel, including a plurality of pixel circuit groups and a plurality of data supply line groups arranged on a base substrate; wherein the plurality of pixel circuit groups correspond to the plurality of data supply line groups; the pixel circuit group includes a plurality of pixel units, each pixel unit includes M pixel circuits with different colors; the pixel circuit group includes 2N columns of pixel circuits, and a same column of pixel circuits included in the pixel circuit group have a same color; wherein N is a multiple of M, and both N and M are positive integers; the data supply line group includes N data supply lines; the data supply lines in the data supply line group are electrically connected to two columns of pixel circuits with the same color in a corresponding pixel circuit group, respectively, and are used to provide data signals to the two columns of pixel circuits with the same color.

Optionally, the display panel further includes a plurality of rows of gate lines; wherein among the two columns of pixel circuits with the same color, pixel circuits located in a same row are electrically connected to different rows of gate lines.

Optionally, the display panel further includes a plurality of rows of gate lines; wherein pixel circuits arranged in a same row among the two columns of pixel circuits with the same color are electrically connected to gate lines respectively, and the pixel circuits arranged in the same row among the two columns of pixel circuits with the same color are used to receive data signals provided by the data supply lines in a time-division manner under the control of gate driving signals provided by the gate lines electrically connected to the pixel circuits arranged in the same row respectively.

Optionally, N equals 6 and M equals 3; the pixel circuit group includes 12 columns of pixel circuits; the data supply line group includes 6 data supply lines; a (3a−2)th column of pixel circuits included in the pixel circuit group are pixel circuits of a first color, a (3a−1)th column of pixel circuits included in the pixel circuit group are pixel circuits of a second color, and a 3ath column of pixel circuits included in the pixel circuit group are pixel circuits of a third color; a is a positive integer less than or equal to 4; a first column of pixel circuits included in the pixel circuit group and a seventh column of pixel circuits included in the pixel circuit group are respectively electrically connected to a first data supply line; a second column of pixel circuits included in the pixel circuit group and an eighth column of pixel circuits included in the pixel circuit group are respectively electrically connected to a second data supply line; a third column of pixel circuits included in the pixel circuit group and a ninth column of pixel circuits included in the pixel circuit group are respectively electrically connected to a third data supply line; a fourth column of pixel circuits included in the pixel circuit group and a tenth column of pixel circuits included in the pixel circuit group are respectively electrically connected to a fourth data supply line; a fifth column of pixel circuits included in the pixel circuit group and an eleventh column of pixel circuits included in the pixel circuit group are respectively electrically connected to a fifth data supply line; a sixth column of pixel circuits included in the pixel circuit group and a twelfth column of pixel circuits included in the pixel circuit group are respectively electrically connected to a sixth data supply line.

Optionally, N equals 3 and M equals 3; the pixel circuit group includes 6 columns of pixel circuits; the data supply line group includes 3 data supply lines; a (3c−2)th column of pixel circuits included in the pixel circuit group is pixel circuits of a first color, and a (3c-1)th column of pixel circuits included in the pixel circuit group is pixel circuits of a second color, and a 3cth column of pixel circuits included in the pixel circuit group is pixel circuits of a third color; c is a positive integer less than or equal to 2; a first column of pixel circuits included in the pixel circuit group and a fourth column of pixel circuits included in the pixel circuit group are respectively electrically connected to a first data supply line; a second column of pixel circuits included in the pixel circuit group and a fifth column of pixel circuits included in the pixel circuit group are respectively electrically connected to a second data supply line; a third column of pixel circuits included in the pixel circuit group and a sixth column of pixel circuits included in the pixel circuit group are respectively electrically connected to a third data supply line.

Optionally, N equals 8 and M equals 4; the pixel circuit group includes 16 columns of pixel circuits; the data supply line group includes 8 data supply lines; a (4a−3)th column of pixel circuits included in the pixel circuit group are pixel circuits of a first color, and a (4a−2)th column of pixel circuits included in the pixel circuit group are pixel circuits of a second color, a (4a−1)th column of pixel circuits included in the pixel circuit group are pixel circuits of a third color, and a 4ath column of pixel circuits included in the pixel circuit group are pixel circuits of a four color; a is a positive integer less than or equal to 4; a first column of pixel circuits included in the pixel circuit group and a ninth column of pixel circuits included in the pixel circuit group are respectively electrically connected to a first data supply line; a second column of pixel circuits included in the pixel circuit group and a tenth column of pixel circuits included in the pixel circuit group are respectively electrically connected to a second data supply line; a third column of pixel circuits included in the pixel circuit group and an eleventh column of pixel circuits included in the pixel circuit group are respectively electrically connected to a third data supply line; a fourth column of pixel circuits included in the pixel circuit group and a twelfth column of pixel circuits included in the pixel circuit group are respectively electrically connected to a fourth data supply line; a fifth column of pixel circuits included in the pixel circuit group and a thirteenth column of pixel circuits included in the pixel circuit group are respectively electrically connected to a fifth data supply line; a sixth column of pixel circuits included in the pixel circuit group and a fourteenth column of pixel circuits included in the pixel circuit group are respectively electrically connected to a sixth data supply line; a seventh column of pixel circuits included in the pixel circuit group and a fifteenth column of pixel circuits included in the pixel circuit group are respectively electrically connected to a seventh data supply line; an eighth column of pixel circuits included in the pixel circuit group and a sixteenth column of pixel circuits included in the pixel circuit group are electrically connected to an eighth data supply line respectively.

Optionally, N equals 4 and M equals 4; the pixel circuit group includes 8 columns of pixel circuits; the data supply line group includes 4 data supply lines; a (4c−3)th column of pixel circuits included in the pixel circuit group are pixel circuits of a first color, and a (4c−2)th column of pixel circuits included in the pixel circuit group are pixel circuits of a second color, a (4c−1)th column of pixel circuits included in the pixel circuit group are pixel circuits of a third color, and a 4cth column of pixel circuits included in the pixel circuit group are pixel circuits of a fourth color; c is a positive integer less than or equal to 2; a first column of pixel circuits included in the pixel circuit group and a fifth column of pixel circuits included in the pixel circuit group are respectively electrically connected to a first data supply line; a second column of pixel circuits included in the pixel circuit group and a sixth column of pixel circuits included in the pixel circuit group are respectively electrically connected to a second data supply line; a third column of pixel circuits included in the pixel circuit group and a seventh column of pixel circuits included in the pixel circuit group are respectively electrically connected to a third data supply line; a fourth column of pixel circuits included in the pixel circuit group and an eighth column of pixel circuits included in the pixel circuit group are respectively electrically connected to a fourth data supply line.

Optionally, a bth row and odd-numbered column of pixel circuit included in the pixel circuit group is electrically connected to a (2b−1)th row of gate line; the bth row and even-numbered column of pixel circuits included in the pixel circuit group is electrically connected to a 2bth row of gate line; or the bth row and even-numbered column of pixel circuit included in the pixel circuit group is electrically connected to the (2b−1)th row of gate line; the bth row and odd-numbered column of pixel circuit included in the pixel circuit group is electrically connected to the 2bth row of gate line; b is a positive integer.

In a second aspect, an embodiment of the present disclosure provides a method for driving the display panel, wherein the method comprises: providing, by the data supply lines in the data supply line group, the data signals for the two columns of pixel circuits with the same color in the corresponding pixel circuit group.

Optionally, the display panel further includes a plurality of rows of gate lines; the pixel circuits arranged in the same row among the two columns of pixel circuits with the same color are used to receive data signals provided by the data supply lines in a time-division manner under the control of gate driving signals provided by the gate lines electrically connected to the pixel circuits arranged in the same row respectively.

In a third aspect, an embodiment of the present disclosure provides a display device, including the display panel.

Optionally, the display device further includes a data driver; wherein the data driver is arranged on a side of the display panel; the pixel circuit group included in the display panel is arranged in a display area, and the data supply line group included in the display panel is arranged between the data driver and the pixel circuit group; the data driver is electrically connected to the data supply lines included in the data supply line group, and is used to provide data signals to the data supply lines.

Optionally, the display device further includes a gate driving circuit; wherein the display panel further comprises a plurality of rows of gate lines; the gate driving circuit is electrically connected to the plurality of rows of gate lines respectively, and is used to provide corresponding gate driving signals to the plurality of rows of gate lines.

### BRIEF DESCRIPTION OF THE DRAWINGS

FIG. 1 is a schematic diagram of the connection relationship between at least one embodiment of the data supply line group and at least one embodiment of the pixel circuit group;

FIG. 2 is a schematic diagram of the connection relationship among the Nth row of pixel circuits and the gate line in (2N−1)th row G2N−1 and the gate line in 2Nth row G2N in at least one embodiment of the present disclosure;

FIG. 3 is a structural diagram of a display panel according to at least one embodiment of the present disclosure;

FIG. 4 is a schematic diagram of the connection relationship between at least one embodiment of the data supply line group and at least one embodiment of the pixel circuit group;

FIG. 5 is a schematic diagram of the connection relationship between at least one embodiment of the data supply line group and at least one embodiment of the pixel circuit group;

FIG. 6 is a schematic diagram of the connection relationship between the Nth row of pixel circuits and the gate line in (2N−1)th row G2N−1 and the gate line 2Nth row G2N in at least one embodiment of the present disclosure;

FIG. 7 is a structural diagram of a display panel according to at least one embodiment of the present disclosure;

FIG. 8 is a schematic diagram of the connection relationship between at least one embodiment of the data supply line group and at least one embodiment of the pixel circuit group;

FIG. 9 is a schematic diagram of the connection relationship between at least one embodiment of the data supply line group and at least one embodiment of the pixel circuit group.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without making creative efforts fall within the scope of protection of the present disclosure.

The transistors used in all embodiments of the present disclosure may be transistors, thin film transistors, field effect transistors, or other devices with the same characteristics. In the embodiment of the present disclosure, in order to distinguish the two electrodes of the transistor except the control electrode, one electrode is called the first electrode and the other electrode is called the second electrode.

In actual operation, when the transistor is a triode, the control electrode may be a base electrode, the first electrode may be a collector, and the second electrode may be an emitter; or, the control electrode may be a base electrode, the first electrode may be an emitter, and the second electrode may be a collector.

In actual operation, when the transistor is a thin film transistor or a field effect transistor, the control electrode may be a gate electrode, the first electrode may be a drain electrode, and the second electrode may be a source electrode; or, the control electrode may be a gate electrode, the first electrode may be a source electrode, and the second electrode may be a drain electrode.

The display panel according to the embodiment of the present disclosure includes a plurality of pixel circuit groups and a plurality of data supply line groups arranged on a base substrate; the pixel circuit groups correspond to the data supply line groups; the pixel circuit group includes a plurality of pixel units, each pixel unit includes M pixel circuits with different colors;

The pixel circuit group includes 2N columns of pixel circuits, and the same column of pixel circuits included in the pixel circuit group have the same color; where N is a multiple of M, and both N and M are positive integers; the data supply line group includes N data supply lines;

The data supply lines in the data supply line group are electrically connected to two columns of pixel circuits with the same color in the corresponding pixel circuit group, respectively, and are used to provide data signals to the two columns of pixel circuits with the same color.

Embodiments of the present disclosure can provide data signals to two columns of pixel circuits with the same color through the same data supply line, thereby avoiding the problem of insufficient charging in the related art when the same data line provides data signals to two columns of pixel circuits with different colors. There is no problem of insufficient charging in the mixed color screen, and the phenomenon of vertical lines during high-frequency display is improved, and the display effect is improved.

In at least one embodiment of the present disclosure, the data signal may be a data voltage signal or a data current signal, and the present disclosure does not limit the specific type of the data signal.

The display panel according to at least one embodiment of the present disclosure further includes a plurality of rows of gate lines;

Among the two columns of pixel circuits with the same color, the same row of pixel circuits are electrically connected to gate lines in different rows.

During specific implementation, the same row of pixel circuits among two columns of pixel circuits with the same color can be electrically connected to gate lines in different rows, but this is not a limitation.

The display panel according to at least one embodiment of the present disclosure further includes a plurality of rows of gate lines;

The same row of pixel circuits among the two columns of pixel circuits with the same color are electrically connected to the gate lines respectively, and the same row of pixel circuits among the two columns of pixel circuits with the same color are used to receive the data signal provided by the data supply line in a time-division manner under the control of the gate driving signal provided by the gate line electrically connected thereto respectively.

In specific implementation, the same row of pixel circuits among the two columns of pixel circuits with the same color receive the data signal provided by the data supply line in a time-division manner under the control of the gate driving signal provided by the gate line electrically connected thereto respectively.

In at least one embodiment of the present disclosure, M may be equal to 3 or 4, but is not limited thereto.

In at least one embodiment of the present disclosure, N may be a multiple of M, but is not limited thereto.

Optionally, when M is equal to 3, the pixel unit may include a red pixel circuit, a green pixel circuit, and a blue pixel circuit;

When M is equal to 4, the pixel circuit may include a red pixel circuit, a green pixel circuit, a blue pixel circuit, and a white pixel circuit.

In at least one embodiment of the present disclosure, the display panel may be a liquid crystal display panel, or the display panel may be an organic light-emitting diode (OLED) display panel;

When the display panel is a liquid crystal display panel, the pixel circuit may include a thin film transistor and a pixel electrode. The pixel electrode is electrically connected to the first electrode of the thin film transistor. The gate electrode of the thin film transistor is electrically connected to the gate line in the corresponding row, the second electrode of the thin film transistor is electrically connected to the data line in the corresponding column;

When the display panel is an OLED display panel, the pixel circuit may include a data writing-in transistor, the gate electrode of the data writing-in transistor is electrically connected to the gate line in the corresponding row, and the first electrode of the data writing-in transistor is connected to the data line in the corresponding column.

In at least one embodiment of the present disclosure, when the display panel is a liquid crystal display panel, when the same row of pixel circuits among two columns of pixel circuits with the same color include the same type of thin film transistors (that is, the same row of pixel circuits among two columns of pixel circuits with the same color only include n type of thin film transistors or, the same row of pixel circuits among two columns of pixel circuits with the same color only include p type of thin film transistors), the same row of pixel circuits among the two columns of pixel circuits with the same color can be electrically connected to gate lines in different rows to receive data signals in a time-division manner;

When the display panel is a liquid crystal display panel, when the same row of pixel circuits among two columns of pixel circuits with the same color include different types of thin film transistors (that is, the same row of pixel circuits among two columns of pixel circuits with the same color only include N or P types of thin film transistors), the same tow of pixel circuits among the two columns of pixel circuits with the same color can be electrically connected to the gate line of the same row and receive the data signal in a time-division manner.

In at least one embodiment of the present disclosure, when the display panel is an OLED display panel, when the same row of pixel circuits among the two columns of pixel circuits having the same color include the same type of data writing-in transistor (that is, the data writing-in transistors included in the same row of pixel circuits among the two columns of pixel circuits with the same color are all n-type transistors; or, the data writing-in transistors included in the same row of pixel circuits among the two columns of pixel circuits having the same color are all p-type transistors), the same row of pixel circuits among the two columns of pixel circuits with the same color can be electrically connected to the gate lines of different rows to receive data signals in a time-division manner;

When the display panel is an OLED display panel, when the same row of pixel circuits among two columns of pixel circuits with the same color include different types of data writing-in transistors (that is, the same row of pixel circuits among two columns of pixel circuits with the same color include n-type transistors or p-type transistors respectively), the same row of pixel circuits among the two columns of the pixel circuits with the same color can be electrically connected to the gate line of the same row to receive the data signals in a time-division manner.

Optionally, N equals 6 and M equals 3; the pixel circuit group includes 12 columns of pixel circuits; the data supply line group includes 6 data supply lines;

The (3a−2)th column of pixel circuits included in the pixel circuit group are pixel circuits of the first color, the (3a−1)th column of pixel circuits included in the pixel circuit group are pixel circuits of the second color, and the 3ath column of pixel circuits included in the pixel circuit group are pixel circuits of the third color; a is a positive integer less than or equal to 4;

The first column of pixel circuits included in the pixel circuit group and the seventh column of pixel circuits included in the pixel circuit group are respectively electrically connected to the first data supply line;

The second column of pixel circuits included in the pixel circuit group and the eighth column of pixel circuits included in the pixel circuit group are respectively electrically connected to the second data supply line;

The third column of pixel circuits included in the pixel circuit group and the ninth column of pixel circuits included in the pixel circuit group are respectively electrically connected to the third data supply line;

The fourth column of pixel circuits included in the pixel circuit group and the tenth column of pixel circuits included in the pixel circuit group are respectively electrically connected to the fourth data supply line;

The fifth column of pixel circuits included in the pixel circuit group and the eleventh column of pixel circuits included in the pixel circuit group are respectively electrically connected to the fifth data supply line;

The sixth column of pixel circuits included in the pixel circuit group and the twelfth column of pixel circuits included in the pixel circuit group are respectively electrically connected to the sixth data supply line.

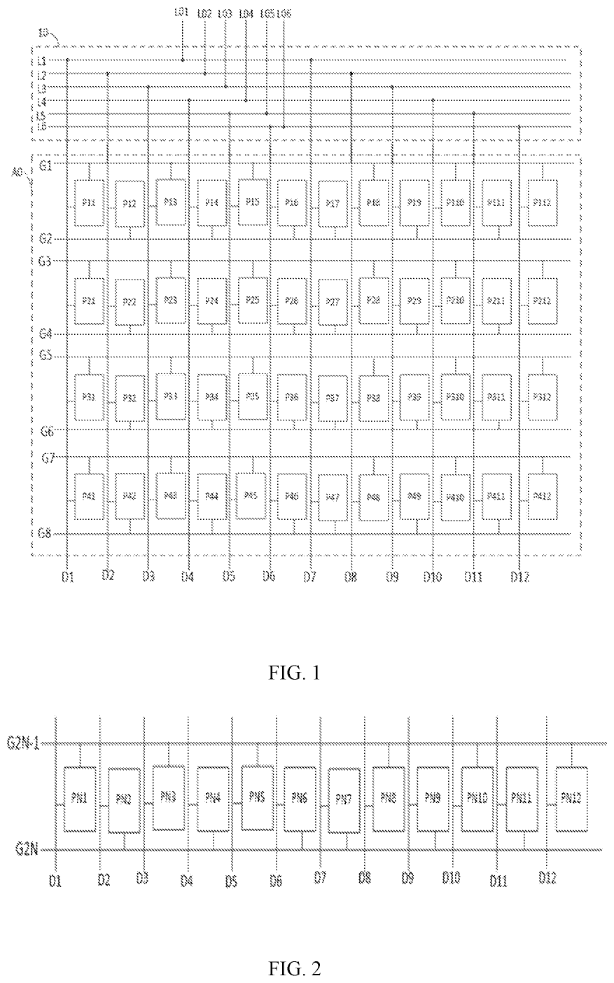

As shown in FIG. 1, the data supply line group may include a first data supply line L1, a second data supply line L2, a third data supply line L3, a fourth data supply line L4, a fifth data supply line L5 and a sixth data supply line L6;

In FIG. 1, the circuit labeled P11 is the pixel circuit of the first row and the first column, the circuit labeled P12 is the pixel circuit of the first row and the second column, the circuit labeled P13 is the pixel circuit of the first row and the third column, and the circuit labeled P14 is the pixel circuit of the first row and the fourth column, the circuit labeled P15 is the pixel circuit of the first row and the fifth column, the circuit labeled P16 is the pixel circuit of the first row and the sixth column, and the circuit labeled P17 is the pixel circuit of the first row and the seventh column, the circuit labeled P18 is the pixel circuit in the first row and eighth column, the circuit labeled P19 is the pixel circuit in the first row and ninth column, the circuit labeled P110 is the pixel circuit in the first row and tenth column, the circuit labeled P111 is the pixel circuit in the first row and the eleventh column, the circuit labeled P112 is the pixel circuit in the first row and the twelfth column;

The one labeled P21 is the pixel circuit of the second row and the first column, the one labeled P22 is the pixel circuit of the second row and the second column, the one labeled P23 is the pixel circuit of the second row and the third column, and the one labeled P24 is the pixel circuit of the second row and the fourth column, the one labeled P25 is the pixel circuit of the second row and fifth column, the one labeled P26 is the pixel circuit of the second row and sixth column, the one labeled P27 is the pixel circuit of the second row and seventh column, the one labeled P28 is the pixel circuit of the second row and eighth column, the one labeled P29 is the pixel circuit of the second row and ninth column, the one labeled P210 is the pixel circuit of the second row and tenth column, the one labeled P211 is the pixel circuit of the second row and tenth column, the one labeled P212 is the pixel circuit of the second row and twelfth column;

The one labeled P31 is the pixel circuit of the third row and the first column, the one labeled P32 is the pixel circuit of the third row and the second column, the one labeled P33 is the pixel circuit of the third row and the third column, and the one labeled P34 is the pixel circuit of the third row and the fourth column, the one labeled P35 is the pixel circuit of the third row and fifth column, the one labeled P36 is the pixel circuit of the third row and sixth column, the one labeled P37 is the pixel circuit of the third row and seventh column, the one labeled P38 is a pixel circuit of the third row and eighth column, the one labeled P39 is a pixel circuit of the third row and ninth column, the one labeled P310 is a pixel circuit of the third row and tenth column, the one labeled P311 is a pixel circuit of the third row and tenth column, the one labeled P312 is the pixel circuit in the third row and twelfth column;

The one labeled P41 is the pixel circuit of the fourth row and the first column, the one labeled P42 is the pixel circuit of the fourth row and the second column, the one labeled P43 is the pixel circuit of the fourth row and the third column, and the one labeled P44 is the pixel circuit of the fourth row and the fourth column, the one labeled P45 is the pixel circuit of the fourth row and fifth column, the one labeled P46 is the pixel circuit of the fourth row and sixth column, the one labeled P47 is the pixel circuit of the fourth row and seventh column, the one labeled P48 is the pixel circuit of the fourth row and eighth column, the one labeled P49 is the pixel circuit of the fourth row and ninth column, the one labeled P410 is a pixel circuit of the fourth row and tenth column, the one labeled P411 is the pixel circuit of the fourth row and eleventh column, the one labeled P412 is the pixel circuit of the fourth row and twelfth column;

P11, P21, P31, P41, P14, P24, P34, P44, P17, P27, P37, P47, P110, P210, P310 and P410 are all red pixel circuits;

P12, P22, P32, P42, P15, P25, P35, P45, P18, P28, P38, P48, P111, P211, P311 and P411 are all green pixel circuits;

P13, P23, P33, P43, P16, P26, P36, P46, P19, P29, P39, P49, P112, P212, P312 and P412 are all blue pixel circuits;

The one labeled D1 is the first column of data line, the one labeled D2 is the second column of data line, the one labeled D3 is the third column of data line, the one labeled D4 is the fourth column of data line, and the one labeled D5 is the fifth column of data line. The one labeled D6 is the sixth column of data line. The one labeled D7 is the seventh column of data line. The one labeled D8 is the eighth column of data line. The one labeled D9 is the ninth column of data line. The one labeled D10 is the tenth column of data line, the one labeled D11 is the eleventh column of data lines, and the one labeled D12 is the twelfth column of data lines;

The one labeled G1 is the first row of gate line, the one labeled G2 is the second row of gate line, the one labeled G3 is the third row of gate line, the one labeled G4 is the fourth row of gate line, and the one labeled G5 is the fifth row of gate line, the one labeled G6 is the sixth row of gate line, the one labeled G7 is the seventh row of gate line, and the one labeled G8 is the eighth row of gate line;

As shown in FIG. 1, P11, P21, P31 and P41 are electrically connected to L1 through D1, and P17, P27, P37 and P47 are electrically connected to L1 through D7;

P12, P22, P32 and P42 are electrically connected to L2 through D2, and P18, P28, P38 and P48 are electrically connected to L2 through D8;

P13, P23, P33 and P43 are electrically connected to L3 through D3, and P19, P29, P39 and P49 are electrically connected to L3 through D9;

P14, P24, P34 and P44 are electrically connected to L4 through D4, and P110, P210, P310 and P410 are electrically connected to L4 through D10;

P15, P25, P35 and P45 are electrically connected to L5 through D5, and P111, P211, P311 and P411 are electrically connected to L5 through D11;

P16, P26, P36 and P46 are electrically connected to L6 through D6, and P112, P212, P312 and P412 are electrically connected to L6 through D12;

P11, P13, P15, P18, P110 and P112 are all electrically connected to G1;

P12, P14, P16, P17, P19 and P111 are all electrically connected to G2;

P21, P23, P25, P28, P210 and P212 are all electrically connected to G3;

P22, P24, P26, P27, P29 and P211 are all electrically connected to G4;

P31, P33, P35, P38, P310 and P312 are all electrically connected to G5;

P32, P34, P36, P37, P39 and P311 are all electrically connected to G6;

P41, P43, P45, P48, P410 and P412 are all electrically connected to G7;

P42, P44, P46, P47, P49 and P411 are all electrically connected to G8;

The first data supply line L1, the second data supply line L2, the third data supply line L3, the fourth data supply line L4, the fifth data supply line L5 and the sixth data supply line L6 are used to provide the data signal provided by the data driver to each pixel circuit;

In FIG. 1, the lead labeled L01 is the first connection lead, the lead labeled L02 is the second connection lead, the lead labeled L03 is the third connection lead, the lead labeled L04 is the fourth connection lead, and the lead labeled L05 is the fifth connecting lead, the one labeled L06 is the sixth connection lead;

L01, L02, L03, L04, L05 and L06 are the connection leads between each data supply line and the data driver. Each connection lead can be set between the fanout area and the display area. The data driver can be set on the chip-on-film (COF), but not limited to this.

As shown in FIG. 1, L1, L2, L3, L4, L5 and L6 are all arranged in the data supply line array area 10, which is arranged in the packaging area; each pixel circuit is arranged in the display area A0.

In at least one embodiment of the display panel shown in FIG. 1, the red pixel circuit located in the first column and the red pixel circuit located in the seventh column are electrically connected to L1, and L1 is used to provide a red data signal;

The green pixel circuit located in the second column and the green pixel circuit located in the eighth column are both electrically connected to L2, and L2 is used to provide a green data signal;

The blue pixel circuit located in the third column and the blue pixel circuit located in the ninth column are both electrically connected to L3, and L3 is used to provide a blue data signal;

The red pixel circuit located in the fourth column and the red pixel circuit located in the tenth column are both electrically connected to L4, and L4 is used to provide a red data signal;

The green pixel circuit located in the fifth column and the green pixel circuit located in the eleventh column are both electrically connected to L5, and L5 is used to provide a green data signal;

The blue pixel circuit located in the sixth column and the blue pixel circuit located in the twelfth column are both electrically connected to L6, and L6 is used to provide a blue data signal.

In at least one embodiment of the present disclosure, the data supply lines are not connected to each other.

In at least one embodiment of the present disclosure, the data supply lines in the same data supply line group only need to be electrically connected to two columns of pixel circuits with the same color, and are not limited to being electrically connected to a specific column of pixel circuits.

In at least one embodiment of the present disclosure, one data line is used to drive pixel circuits with the same color. For example, in at least one embodiment shown in FIG. 1, the first column of data line D1 is only used to drive the red pixel circuits located in the first column, the second column data line D2 is only used to drive the green pixel circuit located in the second column.

In at least one embodiment of the present disclosure, different columns of pixel circuits that are electrically connected to the same data supply line are electrically connected to different row of gate lines, and there is no fixed requirement for the relative relationship between the pixel circuits driven by the data lines connected to different data supply lines, and there are no fixed requirements for the relative relationship between pixel circuits in respective rows.

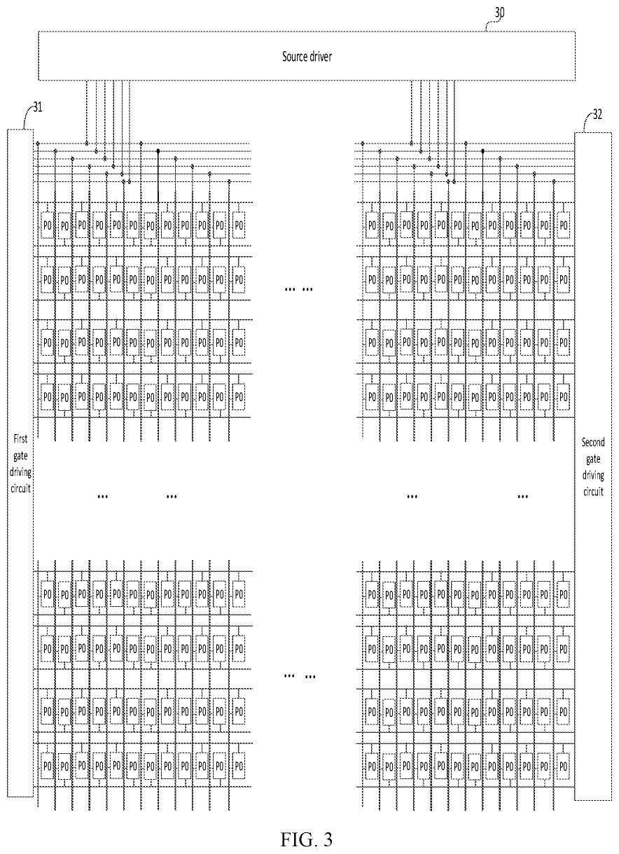

As shown in FIG. 2, the pixel circuit located in the Nth row is electrically connected to the (2N−1)th row of gate line G2N−1 and the 2Nth row of gate line G2N respectively; N is a positive integer;

The pixel circuit PN1 of the Nth row and the first column and the pixel circuit PN7 of the Nth row and the seventh column are a group of pixel circuits; the pixel circuit PN1 of the Nth row and the first column and the pixel circuit PN7 of the Nth row and the seventh column are both red pixel circuits;

The pixel circuit PN2 in the Nth row and the second column and the pixel circuit PN8 in the Nth row and the eighth column are a group of pixel circuits; the pixel circuit PN2 in the Nth row and the second column and the pixel circuit PN8 in the Nth row and the eighth column are both green pixel circuits;

The pixel circuit PN3 in the Nth row and third column and the pixel circuit PN9 in the Nth row and ninth column are a group of pixel circuits; the pixel circuit PN3 in the Nth row and third column and the pixel circuit PN9 in the Nth row and ninth column are both blue pixel circuits;

The pixel circuit PN4 in the Nth row and fourth column and the pixel circuit PN10 in the Nth row and the tenth column are a group of pixel circuits; the pixel circuit PN4 in the Nth row and fourth column and the pixel circuit PN10 in the Nth row and the tenth column are both red pixel circuits;

The pixel circuit PN5 in the Nth row and the fifth column and the pixel circuit PN11 in the Nth row and the 11th column are a group of pixel circuits; the pixel circuit PN5 in the Nth row and the fifth column and the pixel circuit PN11 in the Nth row and the 11th column are both green pixels. circuit;

The pixel circuit PN6 in the Nth row and the sixth column and the pixel circuit PN12 in the Nth row and the 12th column are a group of pixel circuits; the pixel circuit PN6 in the Nth row and the sixth column and the pixel circuit PN12 in the Nth row and the twelfth column are both blue pixel circuits.

In FIG. 2, the one labeled D1 is the first column of data line, the one labeled D2 is the second column of data line, the one labeled D3 is the third column of data line, the one labeled D4 is the fourth column of data line, the one labeled D5 is the fifth column of data line, the one labeled D6 is the sixth column of data line, the one labeled D7 is the seventh column of data line, the one labeled D8 is the eighth column of data line, the one labeled D9 is the ninth column of data line, the one labeled D10 is the tenth column of data line, the one labeled D11 is the eleventh column of data line, the one labeled D12 is the twelfth column of data line.

As shown in FIG. 2, PN1 is electrically connected to G2N−1, PN7 is electrically connected to G2N, PN2 is electrically connected to G2N, PN8 is electrically connected to G2N−1, PN3 is electrically connected to G2N−1, PN9 is electrically connected to G2N, PN4 is electrically connected to G2N is electrically connected, PN10 is electrically connected to G2N−1, PN5 is electrically connected to G2N−1, PN11 is electrically connected to G2N, PN6 is electrically connected to G2N, and PN12 is electrically connected to G2N−1.

In at least one embodiment of the present disclosure, in the Nth row of pixel circuits, one of the pixel circuits in the same group is electrically connected to G2N−1, and the other pixel circuit in the same group is electrically connected to G2N, but it is not limited to the pixel circuits in the same group being connected to a fixed gate line. For example, in at least one embodiment shown in FIG. 2, PN1 can be replaced by being electrically connected to G2N, and PN7 can be replaced by being electrically connected with G2N−1.

The connection relationship between the same group of pixel circuits and gate line in the (N+1)th row of pixel circuits and the connection relationship between the same group of pixel circuits and the gate line in the Nth row of pixel circuits may be the same or different, and there is no fixed requirement. That is, for example, in the Nth row of pixel circuits, PN1 is electrically connected to G2N−1, and PN7 is electrically connected to G2N. In the (N+1)th row of pixel circuits, the (N+1)th row and the first column of pixel circuit can be connected to the (2N+2)th row of gate line, and the (N+1)th row and seventh column of pixel circuit can be electrically connected to the (2N+1)th row of gate line; or, in the (N+1)th row of pixel circuits, the (N+1)th row and the first column of pixel circuits may be electrically connected to the (2N+1)th row of gate line, and the (N+1)th row and seventh column of pixel circuits may be electrically connected to the (2N+2)th row of gate line.

In FIG. 3, the one labeled PO is the pixel circuit, and the source driver 30 provides corresponding data signals for each column of pixel circuits through connecting leads, data supply lines and data lines;

The first gate driving circuit 31 and the second gate driving circuit 32 are used to provide corresponding gate driving signals for each row of gate line.

In at least one embodiment shown in FIG. 3, each data supply line group includes six rows of data supply lines, and each pixel circuit group includes twelve columns of pixel circuits.

In at least one embodiment of the present disclosure, the first gate driving circuit 31 and the second gate driving circuit 32 may be arranged on an array substrate, using GOA (array substrate row driving); or, the first gate driving circuit 31 and the second gate driving circuit 32 may also be arranged on a Chip On Film (COF).

Moreover, in at least one embodiment of the present disclosure, a gate driving circuit can be respectively provided on the left side of the display panel and the right side of the display panel to provide corresponding gate driving signals for each row of gate lines; the gate driving circuit can also be provided on one side of the display panel to provide a corresponding gate driving signal for each row of gate line.

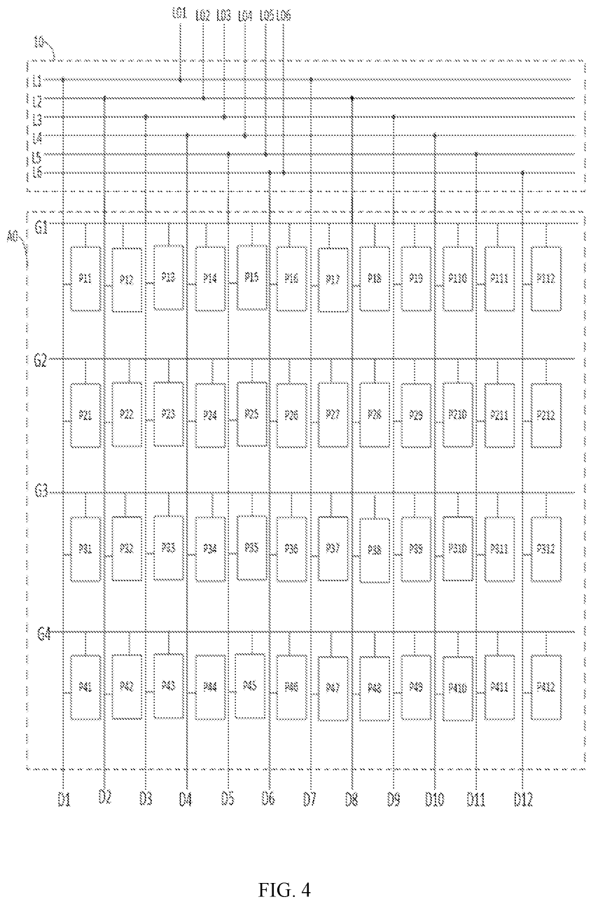

As shown in FIG. 4, the data supply line group may include a first data supply line L1, a second data supply line L2, a third data supply line L3, a fourth data supply line L4, a fifth data supply line L5 and a sixth data supply line L6;

In FIG. 4, the circuit labeled P11 is the pixel circuit of the first row and the first column, the circuit labeled P12 is the pixel circuit of the first row and the second column, the circuit labeled P13 is the pixel circuit of the first row and the third column, and the circuit labeled P14 is the pixel circuit of the first row and the fourth column, the one labeled P15 is the pixel circuit of the first row and the fifth column, the one labeled P16 is the pixel circuit of the first row and the sixth column, and the one labeled P17 is the pixel circuit of the first row and the seventh column, the one labeled P18 is the pixel circuit of the first row and eighth column, the one labeled P19 is the pixel circuit in the first row and ninth column, the one labeled P110 is the pixel circuit of the first row and tenth column, the one labeled P111 is the pixel circuit of the first row and the eleventh column, the one labeled P112 is the pixel circuit of the first row and the twelfth column;

The one labeled P21 is the pixel circuit of the second row and the first column, the one labeled P22 is the pixel circuit of the second row and the second column, the one labeled P23 is the pixel circuit of the second row and the third column, and the one labeled P24 is the pixel circuit of the second row and the fourth column, the one labeled P25 is the pixel circuit of the second row and fifth column, the one labeled P26 is the pixel circuit of the second row and sixth column, the one labeled P27 is the pixel circuit of the second row and seventh column, the one labeled P28 is the pixel circuit of the second row and eighth column, the one labeled P29 is the pixel circuit of the second row and ninth column, the one labeled P210 is the pixel circuit of the second row and tenth column, the one labeled P211 is the pixel circuit of the second row and eleventh column, the one labeled P212 is the pixel circuit of the second row and twelfth column;

The one labeled P31 is the pixel circuit of the third row and the first column, the one labeled P32 is the pixel circuit of the third row and the second column, the one labeled P33 is the pixel circuit of the third row and the third column, and the one labeled P34 is the pixel circuit of the third row and the fourth column, the one labeled P35 is the pixel circuit of the third row and fifth column, the one labeled P36 is the pixel circuit of the third row and sixth column, the one labeled P37 is the pixel circuit of the third row and seventh column, the one labeled P38 is a pixel circuit in the third row and eighth column, the one labeled P39 is a pixel circuit of the third row and ninth column, the one labeled P310 is a pixel circuit of the third row and tenth column, the one labeled P311 is a pixel circuit of the third row and eleventh column, the one labeled P312 is the pixel circuit of the third row and twelfth column;

The one labeled P41 is the pixel circuit of the fourth row and the first column, the one labeled P42 is the pixel circuit of the fourth row and the second column, the one labeled P43 is the pixel circuit of the fourth row and the third column, and the one labeled P44 is the pixel circuit of the fourth row and the fourth column, the one labeled P45 is the pixel circuit of the fourth row and fifth column, the one labeled P46 is the pixel circuit of the fourth row and sixth column, the one labeled P47 is the pixel circuit of the fourth row and seventh column, the one labeled P48 is a pixel circuit of the fourth row and eighth column, the one labeled P49 is a pixel circuit of the fourth row and ninth column, the one labeled P410 is a pixel circuit of the fourth row and tenth column, the one labeled P411 is a pixel circuit of the fourth row and eleventh column, the one labeled P412 is the pixel circuit of the fourth row and twelfth column;

P11, P21, P31, P41, P14, P24, P34, P44, P17, P27, P37, P47, P110, P210, P310 and P410 are all red pixel circuits;

P12, P22, P32, P42, P15, P25, P35, P45, P18, P28, P38, P48, P111, P211, P311 and P411 are all green pixel circuits;

P13, P23, P33, P43, P16, P26, P36, P46, P19, P29, P39, P49, P112, P212, P312 and P412 are all blue pixel circuits;

The one labeled D1 is the first column of data line, the one labeled D2 is the second column of data line, the one labeled D3 is the third column of data line, the one labeled D4 is the fourth column of data line, and the one labeled D5 is the fifth column of data line, the one labeled D6 is the sixth column of data line. The one labeled D7 is the seventh column of data line. The one labeled D8 is the eighth column of data line. The one labeled D9 is the ninth column of data line. The one labeled D10 is the tenth column of data line, the one labeled D11 is the eleventh column of data line, and the one labeled D12 is the twelfth column of data line;

The one labeled G1 is the first row of gate line, the one labeled G2 is the second row of gate line, the one labeled G3 is the third row of gate line, and the one labeled G4 is the fourth row of gate line;

As shown in FIG. 4, P11, P21, P31 and P41 are electrically connected to L1 through D1, and P17, P27, P37 and P47 are electrically connected to L1 through D7;

P12, P22, P32 and P42 are electrically connected to L2 through D2, and P18, P28, P38 and P48 are electrically connected to L2 through D8;

P13, P23, P33 and P43 are electrically connected to L3 through D3, and P19, P29, P39 and P49 are electrically connected to L3 through D9;

P14, P24, P34 and P44 are electrically connected to L4 through D4, and P110, P210, P310 and P410 are electrically connected to L4 through D10;

P15, P25, P35 and P45 are electrically connected to L5 through D5, and P111, P211, P311 and P411 are electrically connected to L5 through D11;

P16, P26, P36 and P46 are electrically connected to L6 through D6, and P112, P212, P312 and P412 are electrically connected to L6 through D12;

P11, P13, P15, P18, P110 and P112 are all electrically connected to G1;

P12, P14, P16, P17, P19 and P111 are all electrically connected to G1;

P21, P23, P25, P28, P210 and P212 are all electrically connected to G2;

P22, P24, P26, P27, P29 and P211 are all electrically connected to G2;

P31, P33, P35, P38, P310 and P312 are all electrically connected to G3;

P32, P34, P36, P37, P39 and P311 are all electrically connected to G3;

P41, P43, P45, P48, P410 and P412 are all electrically connected to G4;

P42, P44, P46, P47, P49 and P411 are all electrically connected to G4;

The first data supply line L1, the second data supply line L2, the third data supply line L3, the fourth data supply line L4, the fifth data supply line L5 and the sixth data supply line L6 are used to provide the data signal provided by the data driver to each pixel circuit;

In FIG. 4, the lead labeled L01 is the first connection lead, the lead labeled L02 is the second connection lead, the lead labeled L03 is the third connection lead, the lead labeled L04 is the fourth connection lead, and the lead labeled L05 is the fifth connecting lead, the one labeled L06 is the sixth connecting lead;

L01, L02, L03, L04, L05 and L06 are the connection leads between each data supply line and the data driver. Each connection lead can be set between the fanout area and the display area. The data driver can be set on COF (chip-on-film), but not limited to this.

As shown in FIG. 4, L1, L2, L3, L4, L5 and L6 are all arranged in the data supply line array area 10, which is arranged in the packaging area; each pixel circuit is arranged in the display area A0.

In at least one embodiment of the display panel shown in FIG. 4, the red pixel circuit located in the first column and the red pixel circuit located in the seventh column are both electrically connected to L1, and L1 is used to provide a red data signal;

The green pixel circuit located in the second column and the green pixel circuit located in the eighth column are both electrically connected to L2, and L2 is used to provide a green data signal;

The blue pixel circuit located in the third column and the blue pixel circuit located in the ninth column are both electrically connected to L3, and L3 is used to provide a blue data signal;

The red pixel circuit located in the fourth column and the red pixel circuit located in the tenth column are both electrically connected to L4, and L4 is used to provide a red data signal;

The green pixel circuit located in the fifth column and the green pixel circuit located in the eleventh column are both electrically connected to L5, and L5 is used to provide a green data signal;

The blue pixel circuit located in the sixth column and the blue pixel circuit located in the twelfth column are both electrically connected to L6, and L6 is used to provide a blue data signal.

In at least one embodiment shown in FIG. 4, two pixel circuits located in the same row and electrically connected to the same data supply line are electrically connected to the same gate line; the transistor include in one of the pixels located in the same row and electrically connected to the same data supply line (when the display panel is a liquid crystal display panel, the transistor is a thin film transistor electrically connected to the pixel electrode, when the display panel is an OLED display panel, the transistor is a data writing-in transistor) is n-type transistors, the transistors included in another pixel circuit located in the same row and electrically connected to the same data supply line are p-type transistors; or, the transistors included in one of the pixel circuits located in the same row and electrically connected to the same data supply line (when the display panel is a liquid crystal display panel, the transistor is a thin film transistor electrically connected to the pixel electrode. When the display panel is an OLED display panel, the transistor is a data writing-in transistor) is a p-type transistor, transistor included in located in another pixel circuit arranged in the same row and electrically connected to the same data supply line is an n-type transistor; through the above settings, two pixel circuits located in the same row and electrically connected to the same data supply line can receive data signals in a time-division manner.

In at least one embodiment of the present disclosure, when two pixel circuits located in the same row and electrically connected to the same data supply line include different types of transistors, the two pixel circuits located in the same row and electrically connected to the same data supply line can also be electrically connected to the same gate line to receive the data signal in a time-division manner.

Optionally, N equals 3 and M equals 3; the pixel circuit group includes 6 columns of pixel circuits; the data supply line group includes 3 data supply lines;

The (3c−2)th column of pixel circuits included in the pixel circuit group is a first color pixel circuit, and the (3c−1)th column of pixel circuits included in the pixel circuit group is a second color pixel circuit, and the 3cth column of pixel circuits included in the pixel circuit group is the third color pixel circuit; c is a positive integer less than or equal to 2;

The first column of pixel circuits included in the pixel circuit group and the fourth column of pixel circuits included in the pixel circuit group are respectively electrically connected to the first data supply line;

The second column of pixel circuits included in the pixel circuit group and the fifth column of pixel circuits included in the pixel circuit group are respectively electrically connected to the second data supply line;

The third column of pixel circuits included in the pixel circuit group and the sixth column of pixel circuits included in the pixel circuit group are respectively electrically connected to the third data supply line.

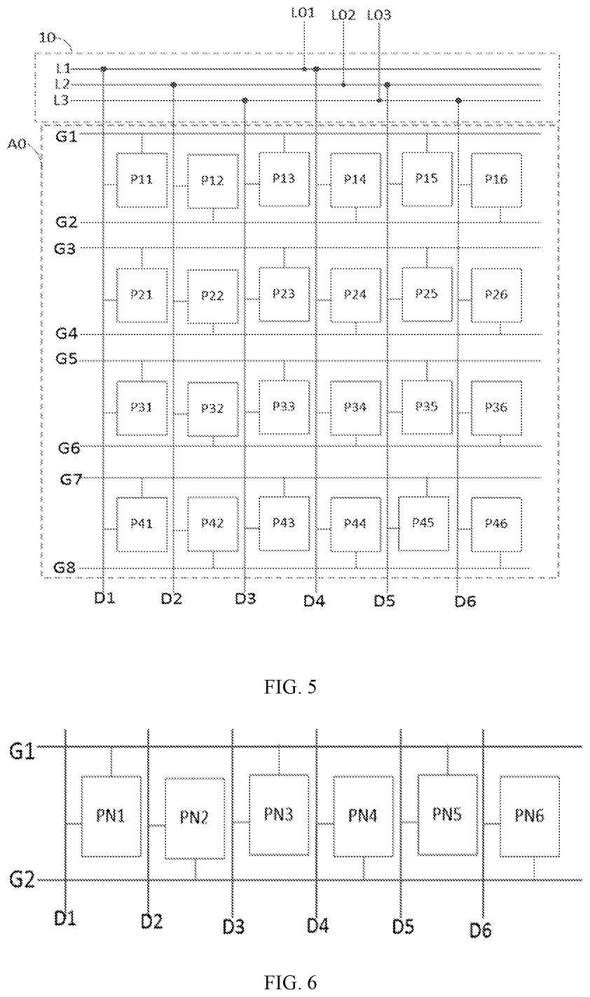

As shown in FIG. 5, the data supply line group may include a first data supply line L1, a second data supply line L2, and a third data supply line L3;

In FIG. 5, the circuit labeled P11 is the pixel circuit of the first row and the first column, the circuit labeled P12 is the pixel circuit of the first row and the second column, the circuit labeled P13 is the pixel circuit of the first row and the third column, and the circuit labeled P14 is the pixel circuit of the first row and the fourth column, the one labeled P15 is the pixel circuit of the first row and the fifth column, and the one labeled P16 is the pixel circuit of the first row and the sixth column;

The one labeled P21 is the pixel circuit of the second row and the first column, the one labeled P22 is the pixel circuit of the second row and the second column, the one labeled P23 is the pixel circuit of the second row and the third column, and the one labeled P24 is the pixel circuit of the second row and the fourth column, the one labeled P25 is the pixel circuit of the second row and fifth column, and the one labeled P26 is the pixel circuit of the second row and sixth column;

The one labeled P31 is the pixel circuit of the third row and the first column, the one labeled P32 is the pixel circuit of the third row and the second column, the one labeled P33 is the pixel circuit of the third row and the third column, and the one labeled P34 is the pixel circuit of the third row and the fourth column, the one labeled P35 is the pixel circuit of the third row and fifth column, and the one labeled P36 is the pixel circuit of the third row and sixth column;

The one labeled P41 is the pixel circuit of the fourth row and the first column, the one labeled P42 is the pixel circuit of the fourth row and the second column, the one labeled P43 is the pixel circuit of the fourth row and the third column, and the one labeled P44 is the pixel circuit of the fourth row and the fourth column, the one labeled P45 is the pixel circuit of the fourth row and fifth column, and the one labeled P46 is the pixel circuit of the fourth row and sixth column;

The one labeled G1 is the first row of gate line, the one labeled G2 is the second row of gate line, the one labeled G3 is the third row of gate line, the one labeled G4 is the fourth row of gate line, and the one labeled G5 is the fifth row of gate line, the one labeled G6 is the sixth row of gate line, the one labeled G7 is the seventh row of gate line, and the one labeled G8 is the eighth row of gate line;

P11, P21, P31, P41, P14, P24, P34 and P44 are all red pixel circuits;

P12, P22, P32, P42, P15, P25, P35 and P451 are all green pixel circuits;

P13, P23, P33, P43, P16, P26, P36 and P46 are all blue pixel circuits;

The one labeled D1 is the first column of data line, the one labeled D2 is the second column of data line, the one labeled D3 is the third column of data line, the one labeled D4 is the fourth column of data line, and the one labeled D5 is the fifth column of data line, and the one labeled D6 is the sixth column of data line.

As shown in FIG. 5, P11, P21, P31 and P41 are electrically connected to L1 through D1, and P14, P24, P34 and P44 are electrically connected to L1 through D4;

P12, P22, P32 and P42 are electrically connected to L2 through D2, and P15, P25, P35 and P45 are electrically connected to L2 through D5;

P13, P23, P33 and P43 are electrically connected to L3 through D3, and P16, P26, P36 and P46 are electrically connected to L3 through D6;

P11, P13 and P15 are all electrically connected to G1;

P12, P14 and P16 are all electrically connected to G2;

P21, P23 and P25 are all electrically connected to G3;

P22, P24 and P26 are all electrically connected to G4;

P31, P33 and P35 are all electrically connected to G5;

P32, P34 and P36 are all electrically connected to G6;

P41, P43 and P45 are all electrically connected to G7;

P42, P44 and P46 are all electrically connected to G8;

The first data supply line L1, the second data supply line L2 and the third data supply line L3 are used to provide data signals provided by the data driver to each pixel circuit;

In FIG. 5, the lead labeled L01 is the first connection lead, the lead labeled L02 is the second connection lead, and the lead labeled L03 is the third connection lead;

L01, L02 and L03 are connection leads between each data supply line and the data driver. The connection leads can be arranged between the fan-out area and the display area. The data driver can be arranged on the COF.

As shown in FIG. 5, L1, L2 and L3 are all arranged in the data supply line array area 10, which is arranged in the packaging area; each pixel circuit is arranged in the display area A0.

In at least one embodiment of the display panel shown in FIG. 5, the red pixel circuit located in the first column and the red pixel circuit located in the fourth column are electrically connected to L1, and L1 is used to provide a red data signal;

The green pixel circuit located in the second column and the green pixel circuit located in the fifth column are both electrically connected to L2, and L2 is used to provide a green data signal;

The blue pixel circuit located in the third column and the blue pixel circuit located in the sixth column are both electrically connected to L3, and L3 is used to provide a blue data signal.

In at least one embodiment of the present disclosure, the data supply lines are not connected to each other.

In at least one embodiment of the present disclosure, the data supply lines in the same data supply line group only need to be electrically connected to two columns of pixel circuits with the same color, and are not limited to being electrically connected to a specific column of pixel circuits.

In at least one embodiment of the present disclosure, one data line is used to drive pixel circuits with the same color. For example, in at least one embodiment shown in FIG. 5, the first column data line D1 is only used to drive the pixel circuits located in the first column, the second column data line D2 is only used to drive the green pixel circuit located in the second column.

In at least one embodiment of the present disclosure, different columns of pixel circuits that are electrically connected to the same data supply line are electrically connected to different row gate lines, and there is no fixed requirement for the relative relationship between the pixel circuits driven by the data lines connected to different data supply lines, and there are no fixed requirements for the relative relationship between pixel circuits in each row.

As shown in FIG. 6, the pixel circuit located in the Nth row is electrically connected to the (2N−1)th row gate line G2N−1 and the 2Nth row gate line G2N respectively; N is a positive integer;

The pixel circuit PN1 of the Nth row and the first column and the pixel circuit PN4 of the Nth row and the fourth column are a group of pixel circuits; the pixel circuit PN1 of the Nth row and the first column and the pixel circuit PN4 of the Nth row and the fourth column are both red pixel circuits;

The pixel circuit PN2 of the Nth row and the second column and the pixel circuit PN5 of the Nth row and the fifth column are a group of pixel circuits; the pixel circuit PN2 of the Nth row and the second column and the pixel circuit PN5 of the Nth row and the fifth column are both green pixel circuits;

The pixel circuit PN3 of the Nth row and third column and the pixel circuit PN6 of the Nth row and sixth column are a group of pixel circuits; the pixel circuit PN3 of the Nth row and third column and the pixel circuit PN6 of the Nth row and ninth column are both blue pixel circuits.

As shown in FIG. 6, PN1 is electrically connected to G2N−1, PN4 is electrically connected to G2N, PN2 is electrically connected to G2N, PN5 is electrically connected to G2N−1, PN3 is electrically connected to G2N−1, and PN6 is electrically connected to G2N.

In FIG. 6, the data line labeled D1 is the first column of data line, the data line labeled D2 is the second column of data line, the data line labeled D3 is the third column of data line, the data line labeled D4 is the fourth column of data line, the data line labeled D5 is the fifth column of data line, the data line labeled D6 is the sixth column of data line.

In at least one embodiment of the present disclosure, in the Nth row of pixel circuits, one of the pixel circuits in the same group is electrically connected to G2N−1, and the other pixel circuit in the same group is electrically connected to G2N, but it is not limited that the pixel circuits in the same group are connected to a fixed gate line. For example, in at least one embodiment shown in FIG. 6, PN1 can be replaced by being electrically connected to G2N, and PN4 can be replaced by being electrically connected with G2N−1.

The connection relationship between the same group of pixel circuits and the gate line in the N+1th row of pixel circuits and the connection relationship between the same group of pixel circuits and the gate line in the Nth row of pixel circuits may be the same or different, and there is no fixed requirement. That is, for example, in the Nth row of pixel circuits, PN1 is electrically connected to G2N−1, and PN4 is electrically connected to G2N. In the (N+1)th row of pixel circuits, the (N+1)th row and first column of pixel circuit can be connected to the (2N+2)th row of gate line, and the (N+1)th row and fourth column of pixel circuits can be electrically connected to the (2N+1)th row of gate line; or, in the (N+1)th row of pixel circuits, the (N+1)th row and the first column of pixel circuit may be electrically connected to the (2N+1)th row of gate line, and the (N+1)th row and fourth column of pixel circuits may be electrically connected to the (2N+2)nd row of gate line.

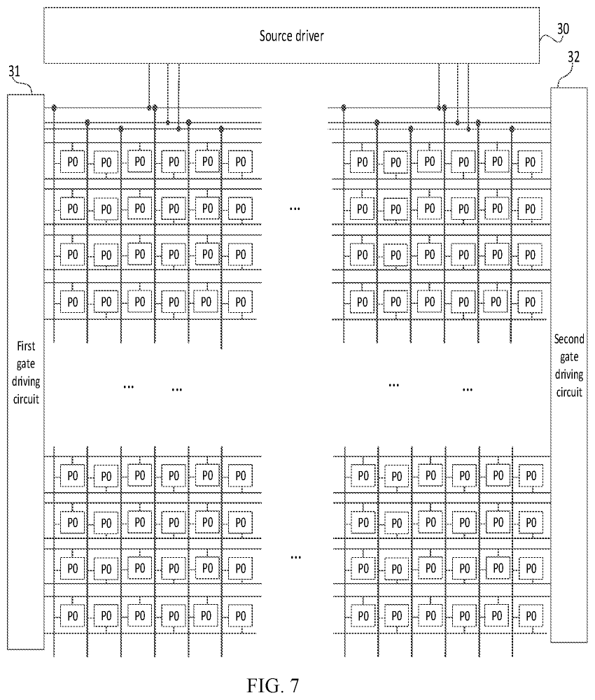

As shown in FIG. 7, the one labeled PO is the pixel circuit, and the source driver 30 provides corresponding data signals for each column of pixel circuits through connecting leads, data supply lines and data lines;

The first gate driving circuit 31 and the second gate driving circuit 32 are used to provide corresponding gate driving signals for each row of gate line.

In at least one embodiment shown in FIG. 7, each data supply line group includes three rows of data supply lines, and each pixel circuit group includes six columns of pixel circuits.

In at least one embodiment of the present disclosure, when M is equal to 3, N is not limited to equal to 3 or 6, and can also be other multiples of 3; for example, N can also be equal to 9 or 12.

Optionally, N equals 8 and M equals 4; the pixel circuit group includes 16 columns of pixel circuits; the data supply line group includes 8 data supply lines;

The (4a−3)th column of pixel circuits included in the pixel circuit group are pixel circuits of the first color, and the (4a−2)th column of pixel circuits included in the pixel circuit group are pixel circuits of the second color, the (4a−1)th column of pixel circuits included in the pixel circuit group are pixel circuits of the third color, and the 4ath column of pixel circuits included in the pixel circuit group is pixel circuits of the four color; a is a positive integer less than or equal to 4;

The first column of pixel circuits included in the pixel circuit group and the ninth column of pixel circuits included in the pixel circuit group are respectively electrically connected to the first data supply line;

The second column of pixel circuits included in the pixel circuit group and the tenth column of pixel circuits included in the pixel circuit group are respectively electrically connected to the second data supply line;

The third column of pixel circuits included in the pixel circuit group and the eleventh column of pixel circuits included in the pixel circuit group are respectively electrically connected to the third data supply line;

The fourth column of pixel circuits included in the pixel circuit group and the twelfth column of pixel circuits included in the pixel circuit group are respectively electrically connected to the fourth data supply line;

The fifth column of pixel circuits included in the pixel circuit group and the thirteenth column of pixel circuits included in the pixel circuit group are respectively electrically connected to the fifth data supply line;

The sixth column of pixel circuits included in the pixel circuit group and the fourteenth column of pixel circuits included in the pixel circuit group are respectively electrically connected to the sixth data supply line;

The seventh column of pixel circuits included in the pixel circuit group and the fifteenth column of pixel circuits included in the pixel circuit group are respectively electrically connected to the seventh data supply line;

The eighth column of pixel circuits included in the pixel circuit group and the sixteenth column of pixel circuits included in the pixel circuit group are electrically connected to the eighth data supply line respectively.

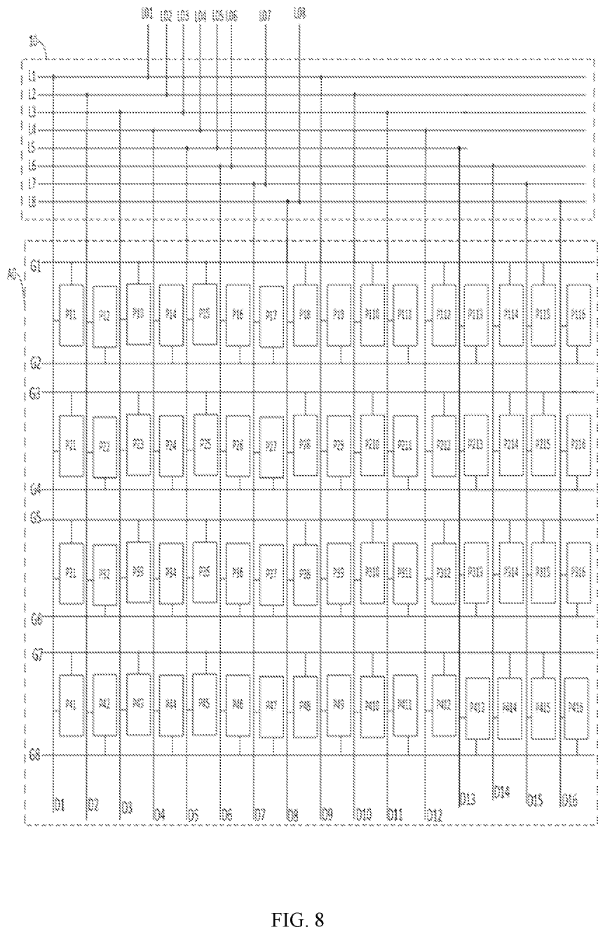

As shown in FIG. 8, the data supply line group may include a first data supply line L1, a second data supply line L2, a third data supply line L3, a fourth data supply line L4, a fifth data supply line L5, a sixth data supply line L6, a seventh data supply line L7 and an eighth data supply line L8;

In FIG. 8, the circuit labeled P11 is the pixel circuit of the first row and the first column, the circuit labeled P12 is the pixel circuit of the first row and the second column, the circuit labeled P13 is the pixel circuit of the first row and the third column, and the circuit labeled P14 is the pixel circuit of the first row and the fourth column, the one labeled P15 is the pixel circuit of the first row and the fifth column, the one labeled P16 is the pixel circuit of the first row and the sixth column, and the one labeled P17 is the pixel circuit of the first row and the seventh column, the one labeled P18 is the pixel circuit in the first row and eighth column, the one labeled P19 is the pixel circuit of the first row and ninth column, the one labeled P110 is the pixel circuit of the first row and tenth column, the one labeled P111 is the pixel circuit of the first row and the eleventh column, the one labeled P112 is the pixel circuit of the first row and the twelfth column, the one labeled P113 is the pixel circuit of the first row and the thirteenth column, and the one labeled P114 is the pixel circuit of the first row and the fourteenth column, the one labeled P115 is the pixel circuit of the first row and the fifteenth column, and the one labeled P116 is the pixel circuit of the first row and the sixteenth column;

The one labeled P21 is the pixel circuit of the second row and the first column, the one labeled P22 is the pixel circuit of the second row and the second column, the one labeled P23 is the pixel circuit of the second row and the third column, and the one labeled P24 is the pixel circuit of the second row and the fourth column, the one labeled P25 is the pixel circuit of the second row and fifth column, the one labeled P26 is the pixel circuit of the second row and sixth column, the one labeled P27 is the pixel circuit of the second row and seventh column, the one labeled is P28 is the pixel circuit of the second row and eighth column, the one labeled P29 is the pixel circuit of the second row and ninth column, the one labeled P210 is the pixel circuit of the second row and tenth column, the one labeled P211 is the pixel circuit of the second row and eleventh column, the one labeled P212 is the pixel circuit of the second row and the twelfth column; the one labeled P213 is the pixel circuit of the second row and the thirteenth column; the one labeled P214 is the pixel circuit of the second row and the fourteenth column, the one labeled P215 is the pixel circuit of the second row and fifteenth column, and the one labeled P216 is the pixel circuit of the second row and sixteenth column;

The one labeled P31 is the pixel circuit of the third row and the first column, the one labeled P32 is the pixel circuit of the third row and the second column, the one labeled P33 is the pixel circuit of the third row and the third column, and the one labeled P34 is the pixel circuit of the third row and the fourth column, the one labeled P35 is the pixel circuit of the third row and fifth column, the one labeled P36 is the pixel circuit of the third row and sixth column, the one labeled P37 is the pixel circuit of the third row and seventh column, the one labeled is P38 is a pixel circuit of the third row and eighth column, the one labeled P39 is a pixel circuit of the third row and ninth column, the one labeled P310 is a pixel circuit of the third row and tenth column, the one labeled P311 is a pixel circuit of the third row and eleventh column, the one labeled P312 is the pixel circuit of the third row and the twelfth column; the one labeled P313 is the pixel circuit of the third row and the thirteenth column; the one labeled P314 is the pixel circuit of the third row and the fourteenth column, the one labeled P315 is the pixel circuit of the third row and fifteenth column, and the one labeled P316 is the pixel circuit of the third row and sixteenth column;

The one labeled P41 is the pixel circuit of the fourth row and the first column, the one labeled P42 is the pixel circuit of the fourth row and the second column, the one labeled P43 is the pixel circuit of the fourth row and the third column, and the one labeled P44 is the pixel circuit of the fourth row and the fourth column, the one labeled P45 is the pixel circuit of the fourth row and fifth column, the one labeled P46 is the pixel circuit of the fourth row and sixth column, the one labeled P47 is the pixel circuit of the fourth row and seventh column, the one labeled is P48 is the pixel circuit of the fourth row and eighth column, the one labeled P49 is a pixel circuit of the fourth row and ninth column, the one labeled P410 is the pixel circuit of the fourth row and tenth column, the one labeled P411 is the pixel circuit of the fourth row and eleventh column, the one labeled P412 is the pixel circuit of the fourth row and the twelfth column; the one labeled P413 is the pixel circuit of the fourth row and the thirteenth column; the one labeled P414 is the pixel circuit of the fourth row and the fourteenth column, the one labeled P415 is the pixel circuit of the fourth row and fifteenth column, and the one labeled P416 is the pixel circuit of the fourth row and sixteenth column;

P11, P21, P31, P41, P15, P25, P35, P45, P19, P29, P39, P49, P113, P213, P313 and P413 are all red pixel circuits;

P12, P22, P32, P42, P16, P26, P36, P46, P110, P210, P310, P410, P114, P214, P314 and P414 are all green pixel circuits;

P13, P23, P33, P43, P17, P27, P37, P47, P111, P211, P311, P411, P115, P215, P315 and P415 are all blue pixel circuits;

P14, P24, P34, P44, P18, P28, P38, P48, P112, P212, P312, P412, P116, P216, P316 and P416 are all white pixel circuits;

The one labeled D1 is the first column of data line, the one labeled D2 is the second column of data line, the one labeled D3 is the third column of data line, the one labeled D4 is the fourth column of data line, and the one labeled D5 is the fifth column of data line, the one labeled D6 is the sixth column of data line. The one labeled D7 is the seventh column of data line. The one labeled D8 is the eighth column of data line. The one labeled D9 is the ninth column of data line. The one labeled D10 is the tenth column of data line, the one labeled D11 is the eleventh column of data line, the one labeled D12 is the twelfth column of data line, the one labeled D13 is the thirteenth column of data line, and the one labeled D14 is the fourteenth column of data line, the one labeled D15 is the fifteenth column of data line, and the one labeled D16 is the sixteenth column of data line;

The one labeled G1 is the first row of gate line, the one labeled G2 is the second row of gate line, the one labeled G3 is the third row of gate line, the one labeled G4 is the fourth row of gate line, and the one labeled G5 is the fifth row of gate line, the one labeled G6 is the sixth row of gate line, the one labeled G7 is the seventh row of gate line, and the one labeled G8 is the eighth row of gate line;

As shown in FIG. 8, P11, P21, P31 and P41 are electrically connected to L1 through D1, and P19, P29, P39 and P49 are electrically connected to L1 through D9;

P12, P22, P32 and P42 are electrically connected to L2 through D2, and P110, P210, P310 and P410 are electrically connected to L2 through D10;

P13, P23, P33 and P43 are electrically connected to L3 through D3, and P111, P211, P311 and P411 are electrically connected to L3 through D11;

P14, P24, P34 and P44 are electrically connected to L4 through D4, and P112, P212, P312 and P412 are electrically connected to L4 through D12;

P15, P25, P35 and P45 are electrically connected to L5 through D5, and P113, P213, P313 and P413 are electrically connected to L5 through D13;

P16, P26, P36 and P46 are electrically connected to L6 through D6, and P114, P214, P314 and P414 are electrically connected to L6 through D14;

P17, P27, P37 and P47 are electrically connected to L7 through D7, and P115, P215, P315 and P415 are electrically connected to L7 through D15;

P18, P28, P38 and P48 are electrically connected to L8 through D8, and P116, P216, P316 and P416 are electrically connected to L8 through D16;

P11, P13, P15, P18, P110, P112, P114 and P115 are all electrically connected to G1;

P12, P14, P16, P17, P19, P111, P113 and P116 are all electrically connected to G2;

P21, P23, P25, P28, P210, P212, P214 and P215 are all electrically connected to G3;

P22, P24, P26, P27, P29, P211, P213 and P216 are all electrically connected to G4;

P31, P33, P35, P38, P310, P312, P314 and P315 are all electrically connected to G5;

P32, P34, P36, P37, P39, P311, P313 and P316 are all electrically connected to G6;

P41, P43, P45, P48, P410, P412, P414 and P415 are all electrically connected to G7;

P42, P44, P46, P47, P49, P411, P413 and P416 are all electrically connected to G8;

The first data supply line L1, the second data supply line L2, the third data supply line L3, the fourth data supply line L4, the fifth data supply line L5, the sixth data supply line L6, the seventh data supply line L7 and the eighth data supply lines L8 are used to provide data signals provided by the data driver to each pixel circuit;

In FIG. 8, the lead labeled L01 is the first connection lead, the lead labeled L02 is the second connection lead, the lead labeled L03 is the third connection lead, the lead labeled L04 is the fourth connection lead, and the lead labeled L05 is the fifth connection lead, the one labeled L06 is the sixth connection lead, the one labeled L07 is the seventh connection lead, and the one labeled L08 is the eighth connection lead;

L01, L02, L03, L04, L05, L06, L07, and L08 provide connection leads between each data supply line and the data driver. The connection leads may be arranged between the fan-out area and the display area, and the data driver may be disposed on the COF.

As shown in FIG. 8, L1, L2, L3, L4, L5, L6, L7 and L8 are all set in the data supply line array area 10, and the data supply line array area 10 is set in the packaging area; each pixel circuit is set in the display area A0.

In at least one embodiment of the display panel shown in FIG. 8, the red pixel circuit located in the first column and the red pixel circuit located in the ninth column are electrically connected to L1, and L1 is used to provide a red data signal;

The green pixel circuit located in the second column and the green pixel circuit located in the tenth column are both electrically connected to L2, and L2 is used to provide a green data signal;

The blue pixel circuit located in the third column and the blue pixel circuit located in the eleventh column are both electrically connected to L3, and L3 is used to provide a blue data signal;

The white pixel circuit located in the fourth column and the white pixel circuit located in the twelfth column are both electrically connected to L4, and L4 is used to provide a white data signal;

The red pixel circuit located in the fifth column and the red pixel circuit located in the thirteenth column are both electrically connected to L5, and L5 is used to provide a red data signal;

The green pixel circuit located in the sixth column and the green pixel circuit located in the fourteenth column are both electrically connected to L6, and L6 is used to provide a green data signal;

The blue pixel circuit located in the seventh column and the blue pixel circuit located in the fifteenth column are both electrically connected to L7, and L7 is used to provide a blue data signal;

The white pixel circuit located in the eighth column and the white pixel circuit located in the sixteenth column are both electrically connected to L8, and L7 is used to provide a white data signal.

In at least one embodiment of the present disclosure, the data supply lines are not connected to each other.

In at least one embodiment of the present disclosure, the data supply lines in the same data supply line group only need to be electrically connected to two columns of pixel circuits with the same color, and are not limited to being electrically connected to a specific column of pixel circuits.

In at least one embodiment of the present disclosure, one data line is used to drive pixel circuits with the same color. For example, in at least one embodiment shown in FIG. 8, the first column of data line D1 is only used to drive the pixel circuits located in the first column, the second column of data line D2 is only used to drive the green pixel circuit located in the second column.

In at least one embodiment of the present disclosure, pixel circuits in different columns that are electrically connected to the same data supply line are electrically connected to different rows of gate lines, and there is no fixed requirements for relative relationship between the pixel circuits driven by the data lines connected to different data supply lines, and there are no fixed requirements for the relative relationship between pixel circuits in respective rows.

Optionally, N equals 4 and M equals 4; the pixel circuit group includes 8 columns of pixel circuits; the data supply line group includes 4 data supply lines;

The (4c−3)th column of pixel circuits included in the pixel circuit group are pixel circuits of a first color, and the (4c−2)th column of pixel circuits included in the pixel circuit group are pixel circuits of a second color. The (4c−1)th column of pixel circuits included in the pixel circuit group are pixel circuits of a third color, and the 4cth column of pixel circuits included in the pixel circuit group are pixel circuits of a fourth color; c is a positive integer less than or equal to 2;

The first column of pixel circuits included in the pixel circuit group and the fifth column of pixel circuits included in the pixel circuit group are respectively electrically connected to the first data supply line;

The second column of pixel circuits included in the pixel circuit group and the sixth column of pixel circuits included in the pixel circuit group are respectively electrically connected to the second data supply line;

The third column of pixel circuits included in the pixel circuit group and the seventh column of pixel circuits included in the pixel circuit group are respectively electrically connected to the third data supply line;

The fourth column of pixel circuits included in the pixel circuit group and the eighth column of pixel circuits included in the pixel circuit group are respectively electrically connected to the fourth data supply line.

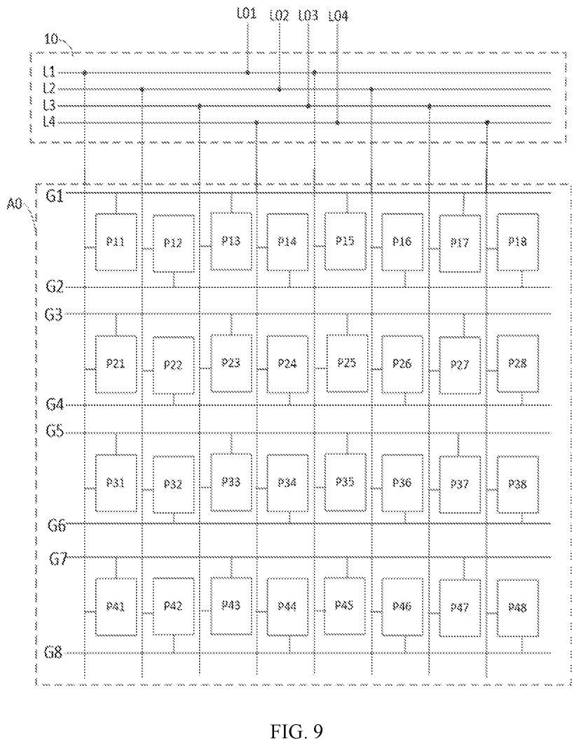

As shown in FIG. 9, the data supply line group may include a first data supply line L1, a second data supply line L2, a third data supply line L3 and a fourth data supply line L4;

In FIG. 9, the one labeled P11 is the pixel circuit of the first row and the first column, the one labeled P12 is the pixel circuit of the first row and the second column, the one labeled P13 is the pixel circuit of the first row and the third column, and the one labeled P14 is the pixel circuit of the first row and the fourth column, the one labeled P15 is the pixel circuit of the first row and the fifth column, the one labeled P16 is the pixel circuit of the first row and the sixth column, and the one labeled P17 is the pixel circuit of the first row and the seventh column, the one labeled P18 is the pixel circuit of the first row and eighth column;

The one labeled P21 is the pixel circuit of the second row and the first column, the one labeled P22 is the pixel circuit of the second row and the second column, the one labeled P23 is the pixel circuit of the second row and the third column, and the one labeled P24 is the pixel circuit of the second row and the fourth column, the one labeled P25 is the pixel circuit of the second row and fifth column, the one labeled P26 is the pixel circuit of the second row and sixth column, the one labeled P27 is the pixel circuit of the second row and seventh column, the one labeled is P28 is the pixel circuit of the second row and the eighth column;

The one labeled P31 is the pixel circuit of the third row and the first column, the one labeled P32 is the pixel circuit of the third row and the second column, the one labeled P33 is the pixel circuit of the third row and the third column, and the one labeled P34 is the pixel circuit of the third row and the fourth column, the one labeled P35 is the pixel circuit of the third row and fifth column, the one labeled P36 is the pixel circuit of the third row and sixth column, the one labeled P37 is the pixel circuit of the third row and seventh column, the one labeled is P38 is the pixel circuit of the third row and the eighth column;

The one labeled P41 is the pixel circuit of the fourth row and the first column, the one labeled P42 is the pixel circuit of the fourth row and the second column, the one labeled P43 is the pixel circuit of the fourth row and the third column, and the one labeled P44 is the pixel circuit of the fourth row and the fourth column, the one labeled P45 is the pixel circuit of the fourth row and fifth column, the one labeled P46 is the pixel circuit of the fourth row and sixth column, the one labeled P47 is the pixel circuit of the fourth row and seventh column, the one labeled is P48 is the pixel circuit of the fourth row and eighth column;

P11, P21, P31, P41, P15, P25, P35 and P45 are all red pixel circuits;

P12, P22, P32, P42, P16, P26, P36 and P46 are all green pixel circuits;

P13, P23, P33, P43, P17, P27, P37 and P47 are all blue pixel circuits;

P14, P24, P34, P44, P18, P28, P38 and P48 are all white pixel circuits;

The one labeled D1 is the first column of data line, the one labeled D2 is the second column of data line, the one labeled D3 is the third column of data line, the one labeled D4 is the fourth column of data line, and the one labeled D5 is the fifth column of data line, the one labeled D6 is the sixth column of data line, the one labeled D7 is the seventh column of data line, and the one labeled D8 is the eighth column of data line;

The one labeled G1 is the first row of gate line, the one labeled G2 is the second row of gate line, the one labeled G3 is the third row of gate line, the one labeled G4 is the fourth row of gate line, and the one labeled G5 is the fifth row of gate line, the one labeled G6 is the sixth row of gate line, the one labeled G7 is the seventh row of gate line, and the one labeled G8 is the eighth row of gate line;

As shown in FIG. 9, P11, P21, P31 and P41 are electrically connected to L1 through D1, and P15, P25, P35 and P45 are electrically connected to L1 through D5;

P12, P22, P32 and P42 are electrically connected to L2 through D2, and P16, P26, P36 and P46 are electrically connected to L2 through D10;

P13, P23, P33 and P43 are electrically connected to L3 through D3, and P17, P27, P37 and P47 are electrically connected to L3 through D11;

P14, P24, P34 and P44 are electrically connected to L4 through D4, and P18, P28, P38 and P48 are electrically connected to L4 through D12;

P11, P13, P15 and P17 are all electrically connected to G1;

P12, P14, P16 and P18 are all electrically connected to G2;

P21, P23, P25 and P27 are all electrically connected to G3;

P22, P24, P26 and P28 are all electrically connected to G4;

P31, P33, P35 and P37 are all electrically connected to G5;

P32, P34, P36 and P38 are all electrically connected to G6;

P41, P43, P45 and P47 are all electrically connected to G7;

P42, P44, P46 and P48 are all electrically connected to G8;

The first data supply line L1, the second data supply line L2, the third data supply line L3 and the fourth data supply line L4 are used to provide data signals provided by the data driver to each pixel circuit;

In FIG. 9, the lead labeled L01 is the first connection lead, the lead labeled L02 is the second connection lead, the lead labeled L03 is the third connection lead, and the lead labeled L04 is the fourth connection lead;

L01, L02, L03, L04, L05, L06, L07, and L08 provide connection leads between each data supply line and the data driver. The connection leads may be arranged between the fan-out area and the display area, and the data driver may be arranged on the COF.

As shown in FIG. 9, L1, L2, L3 and L4 are all arranged in the data supply line array area 10, which is arranged in the packaging area; each pixel circuit is arranged in the display area A0.

In at least one embodiment of the display panel shown in FIG. 9, the red pixel circuit located in the first column and the red pixel circuit located in the fifth column are both electrically connected to L1, and L1 is used to provide a red data signal;

The green pixel circuit located in the second column and the green pixel circuit located in the sixth column are both electrically connected to L2, and L2 is used to provide a green data signal;

The blue pixel circuit located in the third column and the blue pixel circuit located in the seventh column are both electrically connected to L3, and L3 is used to provide a blue data signal;

The white pixel circuit located in the fourth column and the white pixel circuit located in the eighth column are both electrically connected to L4, and L4 is used to provide a white data signal.

In at least one embodiment of the present disclosure, the data supply lines are not connected to each other.

In at least one embodiment of the present disclosure, the data supply lines in the same data supply line group only need to be electrically connected to two columns of pixel circuits with the same color, and are not limited to being electrically connected to a specific column of pixel circuits.

In at least one embodiment of the present disclosure, one data line is used to drive pixel circuits with the same color. For example, in at least one embodiment shown in FIG. 9, the first column of data line D1 is only used to drive the red pixel circuits located in the first column, the second column of data line D2 is only used to drive the green pixel circuit located in the second column.

In at least one embodiment of the present disclosure, pixel circuits in different columns that are electrically connected to the same data supply line are electrically connected to different rows of gate lines, and there is no fixed requirement for relative relationship between the pixel circuits driven by the data lines connected to different data supply lines, and there are no fixed requirements for the relative relationship between pixel circuits in each row.

In at least one embodiment of the present disclosure, the bth row and odd-numbered column of pixel circuits included in the pixel circuit group are electrically connected to the (2b−1)th row of gate line; the bth row and even-numbered column pixel circuits included in the pixel circuit group are electrically connected to the 2bth row of gate line; or the bth row and even-numbered column of pixel circuit included in the pixel circuit group is electrically connected to the (2b−1)th row of gate line; the bth row and odd-numbered column of pixel circuit included in the pixel circuit group is electrically connected to the 2bth row of gate line;

b is a positive integer.

The display panel driving method described in the embodiment of the present disclosure is applied to the above-mentioned display panel. The driving method of the display panel includes:

Providing, by the data supply lines in the data supply line group, data signals for two columns of pixel circuits with the same color in the corresponding pixel circuit group.

Embodiments of the present disclosure can provide data signals to two columns of pixel circuits with the same color through the same data supply line, thereby avoiding the problem of insufficient charging in the related art when the same data line provides data signals to two columns of pixel circuits with different colors. There is no problem of insufficient charging in the mixed color image, and the phenomenon of vertical lines during high-frequency display is improved, and the display effect is improved.

Optionally, the display panel further includes a plurality of rows of gate lines;

Among the two columns of pixel circuits with the same color, the pixel circuits located in the same row are connected to the data signals provided by the data supply lines in a time-division manner under the control of the gate drive signals provided by the gate lines to which they are electrically connected respectively.

The display device according to the embodiment of the present disclosure includes the above-mentioned display panel.

The display device according to at least one embodiment of the present disclosure further includes a data driver;

The data driver is arranged on a side of the display panel;

The pixel circuit group included in the display panel is arranged in the display area, and the data supply line group included in the display panel is arranged between the data driver and the pixel circuit group;

The data driver is electrically connected to the data supply lines included in the data supply line group, and is used to provide data signals to the data supply lines.

In specific implementation, corresponding data signals can be provided for each pixel circuit through a data supply line through a data driver arranged in the fan-out area.

The display device according to at least one embodiment of the present disclosure further includes a gate driving circuit; the display panel further includes a plurality of rows of gate lines;

The gate driving circuit is electrically connected to the plurality of rows of gate lines respectively, and is used to provide corresponding gate driving signals to the gate lines.

During specific implementation, gate driving signals may be provided for each row of gate line through a gate driving circuit.

The display device provided in the embodiment of the present disclosure can be any product or component with a display function such as a mobile phone, a tablet computer, a television, a monitor, a notebook computer, a digital photo frame, a navigator, etc.

The above descriptions are implementations of the present disclosure. It should be pointed out that those skilled in the art can make some improvements and modifications without departing from the principle of the present disclosure. These improvements and modifications shall also fall within the scope of the present disclosure.

1. A display panel, comprising a plurality of pixel circuit groups and a plurality of data supply line groups arranged on a base substrate; wherein the plurality of pixel circuit groups correspond to the plurality of data supply line groups; the pixel circuit group includes a plurality of pixel units, each pixel unit includes M pixel circuits with different colors;
the pixel circuit group includes 2N columns of pixel circuits, and a same column of pixel circuits included in the pixel circuit group have a same color; wherein N is a multiple of M, and both N and M are positive integers; the data supply line group includes N data supply lines;
the data supply lines in the data supply line group are electrically connected to two columns of pixel circuits with the same color in a corresponding pixel circuit group, respectively, and are used to provide data signals to the two columns of pixel circuits with the same color.

2. The display panel according to claim 1, further comprising a plurality of rows of gate lines; wherein
among the two columns of pixel circuits with the same color, pixel circuits located in a same row are electrically connected to different rows of gate lines.

3. The display panel according to claim 1, further comprising a plurality of rows of gate lines; wherein
pixel circuits arranged in a same row among the two columns of pixel circuits with the same color are electrically connected to gate lines respectively, and the pixel circuits arranged in the same row among the two columns of pixel circuits with the same color are used to receive data signals provided by the data supply lines in a time-division manner under the control of gate driving signals provided by the gate lines electrically connected to the pixel circuits arranged in the same row respectively.

4. The display panel according to claim 1, wherein N equals 6 and M equals 3; the pixel circuit group includes 12 columns of pixel circuits; the data supply line group includes 6 data supply lines;
a (3a−2)th column of pixel circuits included in the pixel circuit group are pixel circuits of a first color, a (3a−1)th column of pixel circuits included in the pixel circuit group are pixel circuits of a second color, and a 3ath column of pixel circuits included in the pixel circuit group are pixel circuits of a third color; a is a positive integer less than or equal to 4;
a first column of pixel circuits included in the pixel circuit group and a seventh column of pixel circuits included in the pixel circuit group are respectively electrically connected to a first data supply line;
a second column of pixel circuits included in the pixel circuit group and an eighth column of pixel circuits included in the pixel circuit group are respectively electrically connected to a second data supply line;
a third column of pixel circuits included in the pixel circuit group and a ninth column of pixel circuits included in the pixel circuit group are respectively electrically connected to a third data supply line;
a fourth column of pixel circuits included in the pixel circuit group and a tenth column of pixel circuits included in the pixel circuit group are respectively electrically connected to a fourth data supply line;
a fifth column of pixel circuits included in the pixel circuit group and an eleventh column of pixel circuits included in the pixel circuit group are respectively electrically connected to a fifth data supply line;
a sixth column of pixel circuits included in the pixel circuit group and a twelfth column of pixel circuits included in the pixel circuit group are respectively electrically connected to a sixth data supply line.

5. The display panel according to claim 1, wherein N equals 3 and M equals 3; the pixel circuit group includes 6 columns of pixel circuits; the data supply line group includes 3 data supply lines;
a (3c−2)th column of pixel circuits included in the pixel circuit group is pixel circuits of a first color, and a (3c−1)th column of pixel circuits included in the pixel circuit group is pixel circuits of a second color, and a 3cth column of pixel circuits included in the pixel circuit group is pixel circuits of a third color; c is a positive integer less than or equal to 2;
a first column of pixel circuits included in the pixel circuit group and a fourth column of pixel circuits included in the pixel circuit group are respectively electrically connected to a first data supply line;
a second column of pixel circuits included in the pixel circuit group and a fifth column of pixel circuits included in the pixel circuit group are respectively electrically connected to a second data supply line;
a third column of pixel circuits included in the pixel circuit group and a sixth column of pixel circuits included in the pixel circuit group are respectively electrically connected to a third data supply line.

6. The display panel according to claim 1, wherein N equals 8 and M equals 4; the pixel circuit group includes 16 columns of pixel circuits; the data supply line group includes 8 data supply lines;
a (4a−3)th column of pixel circuits included in the pixel circuit group are pixel circuits of a first color, and a (4a−2)th column of pixel circuits included in the pixel circuit group are pixel circuits of a second color, a (4a−1)th column of pixel circuits included in the pixel circuit group are pixel circuits of a third color, and a 4ath column of pixel circuits included in the pixel circuit group are pixel circuits of a four color; a is a positive integer less than or equal to 4;
a first column of pixel circuits included in the pixel circuit group and a ninth column of pixel circuits included in the pixel circuit group are respectively electrically connected to a first data supply line;
a second column of pixel circuits included in the pixel circuit group and a tenth column of pixel circuits included in the pixel circuit group are respectively electrically connected to a second data supply line;
a third column of pixel circuits included in the pixel circuit group and an eleventh column of pixel circuits included in the pixel circuit group are respectively electrically connected to a third data supply line;
a fourth column of pixel circuits included in the pixel circuit group and a twelfth column of pixel circuits included in the pixel circuit group are respectively electrically connected to a fourth data supply line;
a fifth column of pixel circuits included in the pixel circuit group and a thirteenth column of pixel circuits included in the pixel circuit group are respectively electrically connected to a fifth data supply line;
a sixth column of pixel circuits included in the pixel circuit group and a fourteenth column of pixel circuits included in the pixel circuit group are respectively electrically connected to a sixth data supply line;
a seventh column of pixel circuits included in the pixel circuit group and a fifteenth column of pixel circuits included in the pixel circuit group are respectively electrically connected to a seventh data supply line;
an eighth column of pixel circuits included in the pixel circuit group and a sixteenth column of pixel circuits included in the pixel circuit group are electrically connected to an eighth data supply line respectively.

7. The display panel according to claim 1, wherein N equals 4 and M equals 4; the pixel circuit group includes 8 columns of pixel circuits; the data supply line group includes 4 data supply lines;
a (4c−3)th column of pixel circuits included in the pixel circuit group are pixel circuits of a first color, and a (4c−2)th column of pixel circuits included in the pixel circuit group are pixel circuits of a second color, a (4c−1)th column of pixel circuits included in the pixel circuit group are pixel circuits of a third color, and a 4cth column of pixel circuits included in the pixel circuit group are pixel circuits of a fourth color; c is a positive integer less than or equal to 2;
a first column of pixel circuits included in the pixel circuit group and a fifth column of pixel circuits included in the pixel circuit group are respectively electrically connected to a first data supply line;
a second column of pixel circuits included in the pixel circuit group and a sixth column of pixel circuits included in the pixel circuit group are respectively electrically connected to a second data supply line;
a third column of pixel circuits included in the pixel circuit group and a seventh column of pixel circuits included in the pixel circuit group are respectively electrically connected to a third data supply line;
a fourth column of pixel circuits included in the pixel circuit group and an eighth column of pixel circuits included in the pixel circuit group are respectively electrically connected to a fourth data supply line.

8. The display panel according to claim 4, wherein a bth row and odd-numbered column of pixel circuit included in the pixel circuit group is electrically connected to a (2b−1)th row of gate line; the bth row and even-numbered column of pixel circuits included in the pixel circuit group is electrically connected to a 2bth row of gate line; or the bth row and even-numbered column of pixel circuit included in the pixel circuit group is electrically connected to the (2b−1)th row of gate line; the bth row and odd-numbered column of pixel circuit included in the pixel circuit group is electrically connected to the 2bth row of gate line;
b is a positive integer.

9. A method for driving the display panel according to claim 1, wherein the method comprises:
providing, by the data supply lines in the data supply line group, the data signals for the two columns of pixel circuits with the same color in the corresponding pixel circuit group.

10. The method according to claim 9, wherein the display panel further includes a plurality of rows of gate lines;
the pixel circuits arranged in the same row among the two columns of pixel circuits with the same color are used to receive data signals provided by the data supply lines in a time-division manner under the control of gate driving signals provided by the gate lines electrically connected to the pixel circuits arranged in the same row respectively.

11. A display device, comprising the display panel according to claim 1.

12. The display device according to claim 11, further comprising a data driver; wherein
the data driver is arranged on a side of the display panel;
the pixel circuit group included in the display panel is arranged in a display area, and the data supply line group included in the display panel is arranged between the data driver and the pixel circuit group;
the data driver is electrically connected to the data supply lines included in the data supply line group, and is used to provide data signals to the data supply lines.

13. The display device according to claim 11, further comprising a gate driving circuit; wherein the display panel further comprises a plurality of rows of gate lines;
the gate driving circuit is electrically connected to the plurality of rows of gate lines respectively, and is used to provide corresponding gate driving signals to the plurality of rows of gate lines.

14. The display device according to claim 12, further comprising a gate driving circuit; wherein the display panel further comprises a plurality of rows of gate lines;
the gate driving circuit is electrically connected to the plurality of rows of gate lines respectively, and is used to provide corresponding gate driving signals to the plurality of rows of gate lines.

15. The display panel according to claim 5, wherein a bth row and odd-numbered column of pixel circuit included in the pixel circuit group is electrically connected to a (2b−1)th row of gate line; the bth row and even-numbered column of pixel circuits included in the pixel circuit group is electrically connected to a 2bth row of gate line; or the bth row and even-numbered column of pixel circuit included in the pixel circuit group is electrically connected to the (2b−1)th row of gate line; the bth row and odd-numbered column of pixel circuit included in the pixel circuit group is electrically connected to the 2bth row of gate line;
b is a positive integer.

16. The display panel according to claim 6, wherein a bth row and odd-numbered column of pixel circuit included in the pixel circuit group is electrically connected to a (2b−1)th row of gate line; the bth row and even-numbered column of pixel circuits included in the pixel circuit group is electrically connected to a 2bth row of gate line; or the bth row and even-numbered column of pixel circuit included in the pixel circuit group is electrically connected to the (2b−1)th row of gate line; the bth row and odd-numbered column of pixel circuit included in the pixel circuit group is electrically connected to the 2bth row of gate line;
b is a positive integer.

17. The display panel according to claim 7, wherein a bth row and odd-numbered column of pixel circuit included in the pixel circuit group is electrically connected to a (2b−1)th row of gate line; the bth row and even-numbered column of pixel circuits included in the pixel circuit group is electrically connected to a 2bth row of gate line; or the bth row and even-numbered column of pixel circuit included in the pixel circuit group is electrically connected to the (2b−1)th row of gate line; the bth row and odd-numbered column of pixel circuit included in the pixel circuit group is electrically connected to the 2bth row of gate line;
b is a positive integer.
